(19) United States
(12) Patent Application Publication
(10) Pub. No.: US 2025/0288390 A1
(43) Pub. Date: Sep. 18, 2025

(54) CUSTOMIZED TEMPORARY VENEERS

(71) Applicant: Trion Concepts, Inc., El Paso, TX (US)

(72) Inventors: Mark N. Coreil, Opelousas, LA (US); Christopher C. Cosse, Shreveport, LA (US); Karen Vidaurri, San Antonio, TX (US); Chris Danek, San Carlos, CA (US); Andres Eduardo Gutierrez Hernandez, El Paso, TX (US)

(21) Appl. No.: 19/076,594

(22) Filed: Mar. 11, 2025

Related U.S. Application Data
(60) Provisional application No. 63/564,296, filed on Mar. 12, 2024.
(60) Provisional application No. 63/653,633, filed on May 30, 2024.

(51) Int. Cl. A61C 5/30

(52) U.S. Cl. CPC A61C 5/30

(57) ABSTRACT

Customized temporary veneers. The customized temporary veneers are configured to be temporarily attached to a target region of an individual's dental arch and include a plurality of tooth-covering regions, at least one joining region, and a gum-proximate region. Each tooth-covering region includes a corresponding vestibular region configured to at least partially cover a vestibular surface of a corresponding tooth of the dental arch. The at least one joining region operatively attaches a pair of adjacent tooth-covering regions to one another. The gum-proximate region extends from the plurality of tooth-covering regions and is configured to extend at least partially between the plurality of tooth-covering regions and a gum of the individual's dental arch. The corresponding vestibular region defines a vestibular region thickness, and the gum-proximate region tapers from the vestibular region thickness to a gum-proximate edge that defines a gum-proximate edge thickness.

### RELATED APPLICATIONS

This application claims priority to U.S. Provisional Patent Application No. 63/564,296, which was filed on Mar. 12, 2024, and to U.S. Provisional Patent Application No. 63/653,633, which was filed on May 30, 2024, the complete disclosures of which are hereby incorporated by reference.

### FIELD OF THE DISCLOSURE

The present disclosure relates generally to customized temporary veneers.

### BACKGROUND OF THE DISCLOSURE

A study commissioned by the American Association of Orthodontists found that over one third of American adults are unhappy with the appearance of their teeth, and of this group, thirty-six percent believe they would have a better social life if they had better teeth. Dental veneers are one approach to improving the appearance of an individual's teeth. Generally speaking, dental veneers are tooth-like shells that are attached to the front surface of an individual's existing teeth. Each dental veneer may cover and obscure an existing tooth and is designed to replace the appearance of the existing tooth with a preferred tooth appearance. Dental veneers typically are bonded to the individual's existing teeth using permanent adhesives, and a customer's existing teeth often must be “prepped” before the dental veneers are attached. This prepping can involve permanent modifications to the existing teeth, such as grinding down the existing tooth structures to alter the existing teeth to facilitate a strong and secure bond with the veneers.

Conventionally, an individual seeking dental veneers is provided with a digital or a “wax up” model of their veneer-modified teeth, which they are not able to physically wear in their mouth. In this way, the current dental veneer installation process requires individuals to make permanent decisions about their teeth with limited knowledge about the outcome. Thus, a need exists for improved customized temporary veneers, with such veneers allowing an individual to improve their oral appearance without making permanent decisions and/or to try out various veneer appearances before making permanent decisions.

### SUMMARY OF THE DISCLOSURE

Customized temporary veneers are disclosed herein. The customized temporary veneers are configured to be temporarily attached to a target region of an individual's dental arch and include a plurality of tooth-covering regions, at least one joining region, and a gum-proximate region. Each tooth-covering region of the plurality of tooth-covering regions includes a corresponding vestibular region configured to at least partially cover a vestibular surface of a corresponding tooth of a plurality of corresponding teeth of the dental arch. The at least one joining region operatively attaches a pair of adjacent tooth-covering regions of the plurality of tooth-covering regions to one another. The gum-proximate region extends from the plurality of tooth-covering regions and is configured to extend at least partially between the plurality of tooth-covering regions and a gum of the individual's dental arch. The corresponding vestibular region defines a vestibular region thickness, the gum-proximate region tapers from the vestibular region thickness to a gum-proximate edge that defines a gum-proximate edge thickness, and a ratio of the gum-proximate edge thickness to the vestibular region thickness is at least 0.15 and at most 0.9.

### BRIEF DESCRIPTION OF THE DRAWINGS

FIG. 1 is a schematic illustration of examples of customized temporary veneers according to the present disclosure installed within an individual's mouth.

FIG. 2 is a more schematic illustration of examples of customized temporary veneers according to the present disclosure.

FIG. 3 is a schematic illustration of an example of a customized temporary veneer according to the present disclosure and illustrating an example of a position for a flexible joining region.

FIG. 4 is a schematic illustration of an example of a customized temporary veneer according to the present disclosure and illustrating additional examples of positions for flexible joining regions.

FIG. 5 is a schematic illustration of an example of a customized temporary veneer according to the present disclosure and illustrating additional examples of positions for flexible joining regions.

FIG. 6 is a schematic illustration of an example of a customized temporary veneer according to the present disclosure and illustrating additional examples of positions for flexible joining regions.

FIG. 7 is a schematic cross-sectional view illustrating examples of the customized temporary veneers of FIG. 1 taken along line A-A of FIG. 1.

FIG. 8 is a schematic cross-sectional view illustrating additional examples of the customized temporary veneers of FIG. 1 taken along line A-A of FIG. 1.

FIG. 9 is a alternative schematic cross-sectional view illustrating additional examples of the customized temporary veneers of FIG. 1 taken along line A-A of FIG. 1.

FIG. 10 is an alternative schematic cross-sectional view illustrating additional examples of the customized temporary veneers of FIG. 1 taken along line A-A of FIG. 1.

FIG. 11 is a schematic illustration of an example of a customized temporary veneer according to the present disclosure that includes a relief region.

FIG. 12 is a schematic cross-sectional view illustrating an example of a customized temporary veneer according to the present disclosure.

FIG. 13 is a schematic illustration of an example of a customized temporary veneer according to the present disclosure and illustrating inclusion of different materials within different regions of the customized temporary veneer.

FIG. 14 is a schematic illustration of an example of a customized temporary veneer according to the present disclosure that includes an example of an interlock structure.

FIG. 15 is a less schematic illustration of a customized temporary veneer according to the present disclosure viewed in a palatal direction.

### DETAILED DESCRIPTION AND BEST MODE OF THE DISCLOSURE

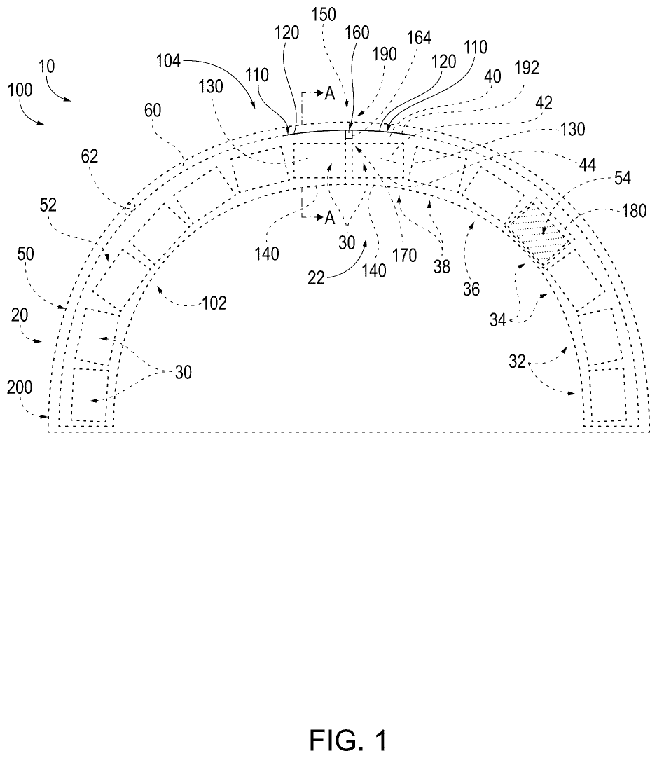

FIGS. 1-15 provide examples of customized temporary veneers 100 according to the present disclosure. Elements that serve a similar, or at least substantially similar, purpose are labeled with like numbers in each of FIGS. 1-15, and these elements may not be discussed in detail herein with reference to each of FIGS. 1-15. Similarly, all elements may not be labeled in each of FIGS. 1-15, but reference numerals associated therewith may be utilized herein for consistency. Elements, components, and/or features that are discussed herein with reference to one or more of FIGS. 1-15 may be included in and/or utilized with any of FIGS. 1-15 without departing from the scope of the present disclosure.

In general, elements that are likely to be included in a particular embodiment are illustrated in solid lines, while elements that may be optional are illustrated in dashed lines. However, elements that are shown in solid lines may not be essential to all embodiments and, in some embodiments, may be omitted without departing from the scope of the present disclosure.

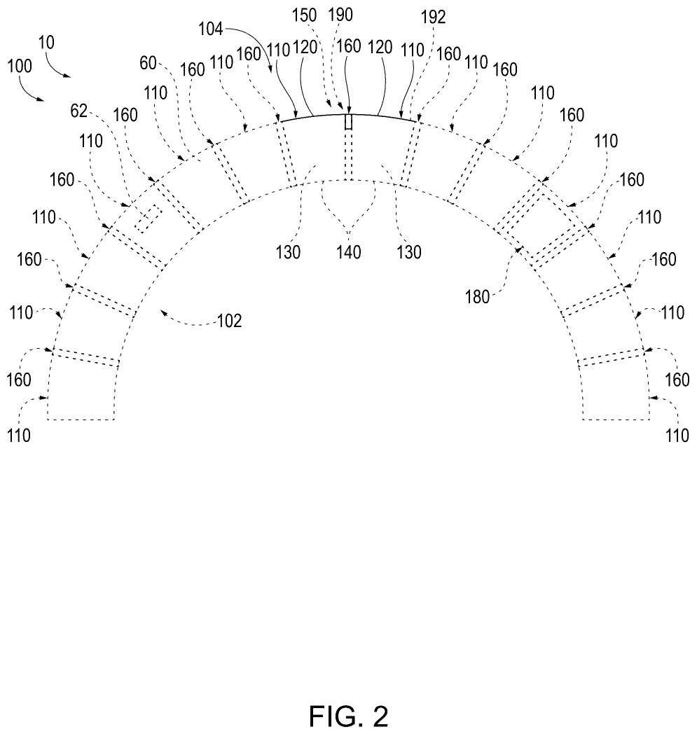

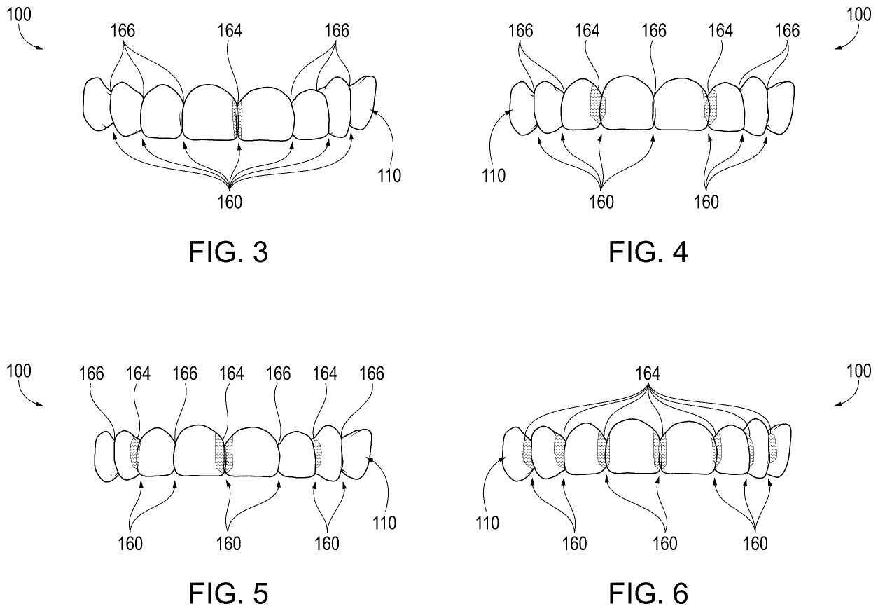

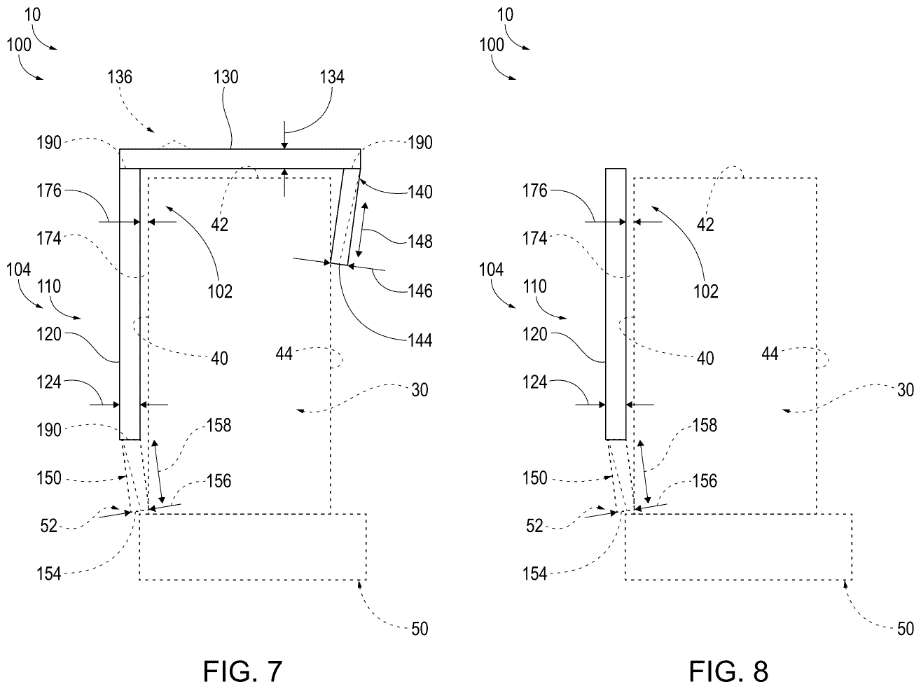

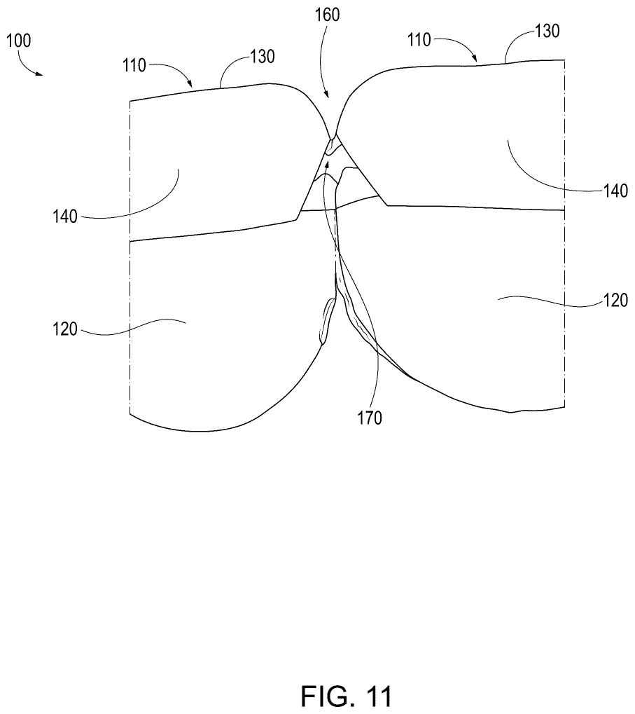

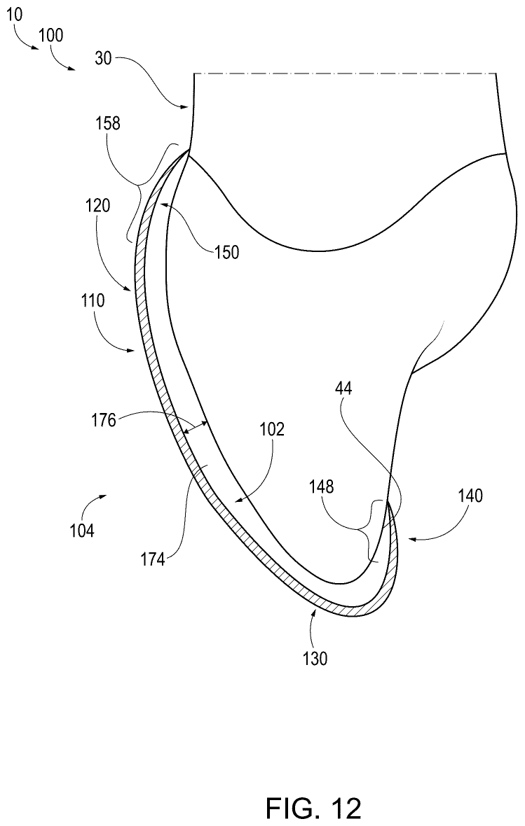

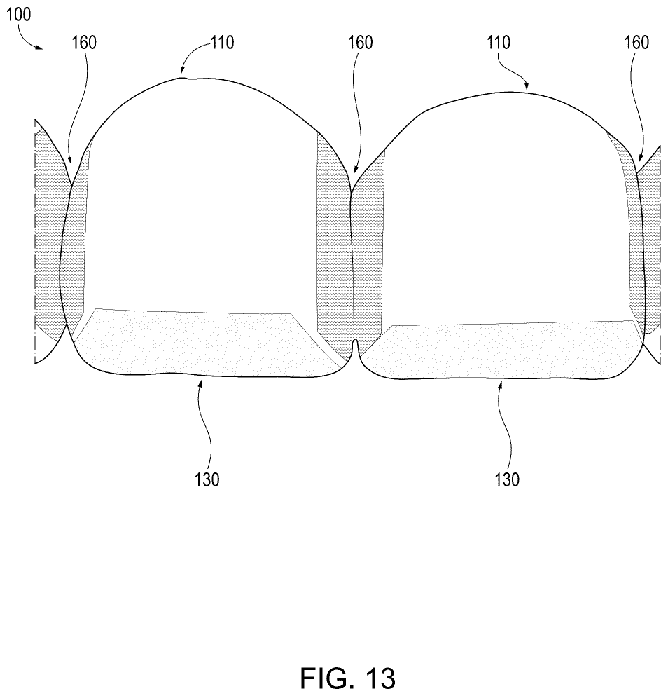

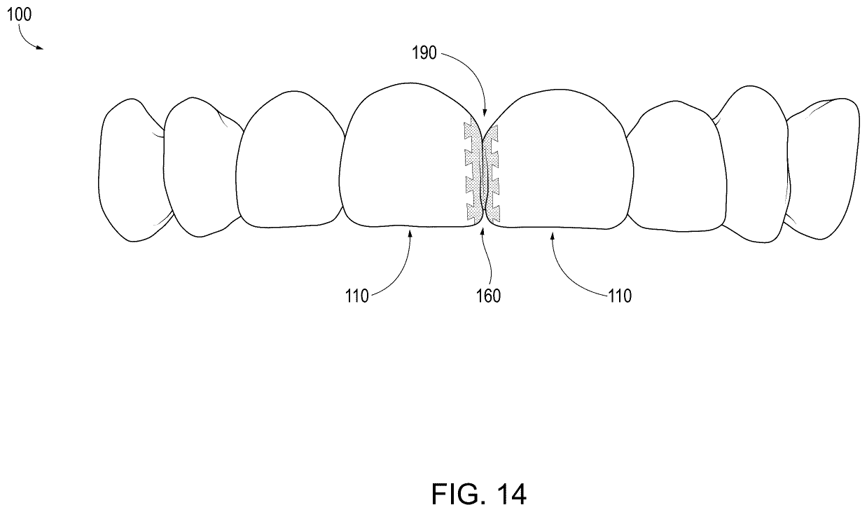

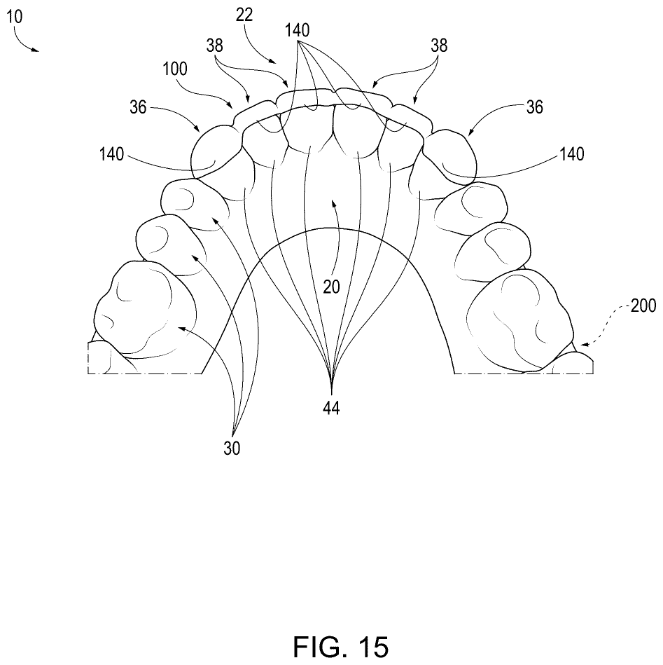

FIG. 1 is a schematic illustration of examples of customized temporary veneers 100 according to the present disclosure installed within an individual's mouth 10, and FIG. 2 is a more schematic illustration of examples of customized temporary veneers 100. FIGS. 3-6 are schematic illustrations of examples of a customized temporary veneer 100 according to the present disclosure and illustrating examples of positions for a flexible joining region 164. FIGS. 7-10 are schematic cross-sectional views illustrating examples of the customized temporary veneer of FIG. 1 taken along line A-A of FIG. 1. FIG. 11 is a schematic illustration of an example of a customized temporary veneer 100 according to the present disclosure that includes a relief region 170. FIG. 12 is a schematic cross-sectional view illustrating an example of a customized temporary veneer 100 according to the present disclosure. FIG. 13 is a schematic illustration of an example of a customized temporary veneer 100 according to the present disclosure and illustrating inclusion of different materials within different regions of the customized temporary veneer. FIG. 14 is a schematic illustration of an example of a customized temporary veneer 100 according to the present disclosure that includes an example of an interlock structure 190. FIG. 15 is a less schematic illustration of a customized temporary veneer 100 according to the present disclosure viewed in a palatal direction.

As collectively illustrated in FIGS. 1-15, and with specific reference to FIG. 1, customized temporary veneers 100 are configured to be temporarily and/or selectively attached to and/or positioned within a target region 22 of an individual's dental arch 20, such as to provide a desired oral appearance to the individual's mouth 10 and/or to improve at least one function of the individual's mouth. As an example, customized temporary veneers 100, which also may be referred to herein as veneers 100, may be utilized to cover and/or to temporarily replace broken, damaged, maloccluded, and/or missing teeth 30, thereby improving the appearance of the individual's mouth and/or improving the individual's ability to chew. This may range from temporary tooth replacement to temporary restoration of the entire dental arch. Stated differently, veneers 100 may extend over and/or across a plurality of corresponding teeth 30 of dental arch 20.

As another example, veneers 100 may be utilized to customize tooth aesthetics, such as shape, embrasure, length, occlusion, color, and/or shade, at least when viewed from external the individual's mouth. As another example, veneers 100 may be utilized to mask and/or to cover gum recession and/or to provide an appearance of a gumline with a desired size, shape, and/or position within the dental arch. As another example, veneers 100 may be utilized to therapeutically correct the gumline, such as via selectively encouraging gum growth, discouraging gum growth, and/or shaping the gums within various regions of the dental arch. As another example, veneers 100 may be utilized to supply medication to the dental arch and/or to the gums.

As another example, a plurality of (non-identical) veneers 100 may be provided to an individual, with the plurality of veneers 100 being configured to permit the individual to select a preferred appearance from a plurality of appearances corresponding to when the individual is wearing the plurality of veneers and/or permitting the appearance of the individual's mouth to be selectively changed while the individual is wearing the veneers. As a more specific example, veneers 100 may permit the individual to trial, test, and/or observe personal and/or public perceptions of a given change to the individual's mouth without, or prior to, more permanent changes to the individual's mouth. As even more specific examples, veneers 100 may permit the individual to experience tooth lengthening, tooth shortening, gum removal, gum lengthening, and/or tooth whitening prior to permanent changes to the individual's mouth.

As another example, a plurality of (non-identical) veneers 100 may be provided to an individual, with the plurality of veneers 100 being configured to permit a progressive change in one or more apparent aspects of the individual's mouth and/or to provide decreased discomfort that may accompany a more abrupt change in the one or more aspects of the individual's mouth as the plurality of veneers 100 are sequentially worn by the individual. In a more specific example, the apparent length of the individual's teeth may be selectively and/or progressively increased utilizing veneers 100. In another more specific example, the apparent sharpness and/or apparent shape of the individual's teeth may be selectively and/or progressively changed utilizing veneers 100. In certain examples, the individual may be given a series, or a set, of veneers 100 that is configured to be utilized, in sequence, to progressively change the appearance of the individual's mouth. In such examples, and because veneers 100 are configured to be selectively and repeatedly manually removed and/or installed by the individual without requiring specialized tools and/or the assistance of a dental practitioner, veneers 100 may permit the individual to select their desired appearance and/or to progress through the series of veneers at their own pace. This represents a significant improvement over conventional veneers, which are glued to the individual's teeth and thus require an office visit with a dental practitioner for removal and/or replacement.

In many of the above examples, a final result of a treatment process that utilizes veneers 100 may include a permanent, or an at least semi-permanent, change to the individual's dental arch and/or change to the appearance of the individual's mouth. In such examples, it may be beneficial for the individual to personally experience, including seeing and/or feeling, the change to their dental arch and/or the change to the appearance of their mouth prior to any permanent, or semi-permanent, changes. Veneers 100 facilitate such an individualized and personalized experience. As a specific example, veneers 100 may be utilized to permit the individual to personally experience an adjustment in occlusion of one or more teeth prior to the actual adjustment in occlusion being performed within the individual's dental arch.

As discussed in more detail herein, veneers 100 are not intended to be permanently installed in an individual's mouth, such as with a permanent adhesive and/or bone screw and/or after destructive reshaping of the individual's existing teeth to accommodate the temporary veneers. Instead, veneers 100 are configured to be selectively and repeatedly attached to and removed from the individual's dental arch without damage or destruction of the veneer or the individual's corresponding teeth to which the veneers are attached. Veneers 100 thus also are distinct from single-use tooth coverings or veneer-like coverings that are only configured to be secured to an individual's dental arch once to provide an example of the appearance of a permanent veneer, with such single-use coverings being damaged or destroyed after prolonged attachment and/or after removal subsequent to the initial attachment to the individual's teeth.

Veneers 100 include a plurality of tooth-covering regions 110 and at least one joining region 160. Each tooth-covering region 110 may include a corresponding vestibular region 120, which is configured to at least partially, at least substantially, or even completely, cover a vestibular surface 40 of a corresponding tooth 30 of dental arch 20. Stated differently, each tooth-covering region 110 is configured to at least partially, at least substantially, or even completely, obscure the vestibular surface of the corresponding tooth when viewed from outside the individual's mouth. Stated still differently, veneer 100 may present an outward-facing side, or surface, 104, instead of the vestibular surface of the corresponding tooth, to be viewed from outside the individual's mouth. Joining region 160 operatively attaches a pair of adjacent tooth-covering regions 110 to one another.

In the following discussion, a variety of properties, features, configurations, components, and/or constructions for veneers 100 are discussed. These properties, features, configurations, components, and/or constructions may be implemented individually, in selected combinations, or collectively within the scope of the present disclosure.

In some examples, veneers 100 may have and/or exhibit a desired, target, specific, and/or localized flexibility. Such a configuration may aid in selective attachment of the veneer to the target region of the individual's dental arch, may aid in intentional separation of the veneer from the target region of the individual's dental arch without damage or destruction of the veneer, and/or may increase the individual's comfort while the veneer is attached to the target region of the individual's dental arch.

As an example, veneers 100, tooth-covering regions 110, and/or joining region 160 may be at least partially, or even completely, formed and/or defined by a flexible polymeric material, which may be selected and/or positioned to provide the desired flexibility. Examples of such a flexible polymeric material include a polymeric resin, an epoxy, a polymethyl methacrylate (PMMA), a flexible PMMA, and/or a dental resin. In some examples, the flexible polymeric material may be a biocompatible flexible polymeric resin, such as may be approved for use within the individual's mouth.

The flexible polymeric resin may have and/or exhibit a desired and/or target flexural strength. Examples of the desired flexural strength include at least 50 megapascals (MPa), at least 52 MPa, at least 54 MPa, at least 56 MPa, at least 58 MPa, at least 60 MPa, at least 62 MPa, at least 64 MPa, at least 66 MPa, at least 68 MPa, at most 76 MPa, at most 74 MPa, at most 72 MPa, at most 70 MPa, at most 68 MPa, at most 66 MPa, at most 64 MPa, at most 62 MPa, and/or at most 60 MPa. Such flexural strength values may permit a desired amount, or magnitude, of flex and/or bending within veneers 100 without damage and/or failure of the veneers.

Additionally or alternatively, the flexible polymeric resin may have and/or exhibit a desired, or target, flexural modulus. Examples of the desired flexural modulus include at least 1300 MPa, at least 1350 MPa, at least 1400 MPa, at least 1450 MPa, at least 1500 MPa, at least 1550 MPa, at least 1600 MPa, at least 1650 MPa, at least 1700 MPa, at most 1900 MPa, at most 1850 MPa, at most 1800 MPa, at most 1750 MPa, at most 1700 MPa, at most 1650 MPa, and/or at most 1600 MPa. Such flexural modulus values may permit veneers 100 to exhibit a desired flexibility or resistance to bending.

Additionally or alternatively, the flexible polymeric resin may have and/or exhibit a desired, or target, elongation at break. Examples of the desired elongation at break include at least 10%, at least 15%, at least 20%, at least 25%, at least 30%, at least 35%, at least 40%, at least 45%, at least 50%, at least 55%, at least 60%, at most 70%, at most 65%, at most 60%, at most 55%, at most 50%, at most 45%, at most 40%, and/or at most 35%. Such elongation at break values may permit veneers 100 to stretch and/or elongate a desired amount without damage, permanent deformation, and/or failure (i.e., breakage) of the veneers.

Additionally or alternatively, the flexible polymeric resin may have and/or exhibit a desired, or target, Shore D Hardness. Examples of the desired Shore D Hardness include at least 70D, at least 72D, at least 74D, at least 76D, at least 78D, at least 80D, at most 90D, at most 88D, at most 86D, at most 84D, at most 82D, and/or at most 80D. Such Shore D Hardness value may permit veneers 100 to exhibit a desired degree of resistance to damage, indentation, and/or wear.

Additionally or alternatively, the flexible polymeric resin may have and/or exhibit a desired, or target, water sorption. Examples of the desired water sorption include at least 6 micrograms per cubic millimeter (ug/mm³), at least 8 ug/mm³, at least 10 ug/mm³, at least 12 ug/mm³, at least 14 ug/mm³, at most 35 ug/mm³, at most 30 ug/mm³, at most 25 ug/mm³, at most 20 ug/mm³, at most 15 ug/mm³, and/or at most 10 ug/mm³. Such water sorption values may permit veneers 100 to be utilized in a wet environment, such as the individual's mouth, without substantial swelling, deformation, and/or change in material properties of the veneers due to water sorption.

Additionally or alternatively, the flexible polymeric resin may have and/or exhibit a desired, or target, water solubility. Examples of the desired water solubility include at least 0.5 ug/mm³, at least 0.75 ug/mm³, at least 1 ug/mm³, at least 1.25 ug/mm³, at least 1.5 ug/mm³, at least 2 ug/mm³, at most 6 ug/mm³, at most 5.5 ug/mm³, at most 5 ug/mm³, at most 4.5 ug/mm³, at most 4 ug/mm³, at most 3.5 ug/mm³, at most 3 ug/mm³, at most 2.5 ug/mm³, at most 2 ug/mm³, at most 1.5 ug/mm³, and/or at most 1 ug/mm³. Such water solubility values may permit veneers 100 to be utilized in the wet environment for an extended period of time and/or without substantial loss of material from the veneers due to dissolution in water.

In a specific example, joining region 160 may include and/or be a flexible joining region 164, which may be at least partially, or even completely, defined by the flexible polymeric material. In such examples, flexible joining region 164 also may be referred to herein as and/or may be a living hinge mechanism between the adjacent tooth-covering regions 110. Such a flexible joining region 164 may be more flexible than the adjacent tooth-covering regions 110 and thus may permit selective (and repeated) pivoting or flexing of the adjacent tooth-covering regions relative to each other. In some examples, flexible joining region 164 may be formed from a different material than the adjacent tooth-covering regions 110, formed from a more flexible material than the adjacent tooth-covering regions, and/or formed from a thinner material than the adjacent tooth-covering regions 110.

FIG. 1 illustrates tooth-covering regions 110 as covering two front incisor teeth 38 of dental arch 20. However, it is within the scope of the present disclosure that veneers 100 may be constructed to cover different and/or a greater number of teeth within a dental arch and may include corresponding tooth-covering regions 110 to cover such other teeth. For example, veneers 100 and tooth-covering regions 110 thereof may be shaped and/or positioned to cover molar 32, premolar 34, canine 36, and/or incisor 38 teeth of dental arch 20.

FIGS. 1-2 also illustrate veneers 100 as including two tooth-covering regions 110 and one joining region 160 (i.e., in solid lines), which may be configured to be temporarily attached to two corresponding teeth 30, as illustrated in FIG. 1. However, and as perhaps best illustrated in FIG. 2, veneers 100 may include any suitable number of tooth-covering regions 110 and corresponding joining regions 160. As examples, veneers 100 may include 2, 3, 4, 5, 6, 7, 8, 9, 10, 11, 12, 13, 14, 15, or 16 tooth-covering regions 110 and 1, 2, 3, 4, 5, 6, 7, 8, 9, 10, 11, 12, 13, 14, or 15 joining regions 160, with each joining region 160 being positioned between a corresponding pair of adjacent tooth-covering regions 110. Stated differently, veneers 100 may be configured to be temporarily attached to or to cover at least 2, at least 4, at least 6, at least 8, at least 10, at least 12, at least 14 teeth, at most 16, at most 14, at most 12, at most 10, at most 8, at most 6, at most 4, and/or at most 2 teeth of a given dental arch.

With the above in mind, it is within the scope of the present disclosure that flexible joining region 164 may be positioned at any suitable location within veneers 100, and FIGS. 3-6 illustrate examples of such positioning. In addition, FIGS. 3-5 also illustrate that joining regions 160 additionally or alternatively may include rigid joining regions 166. Rigid joining regions 166 may be inflexible, may be at least substantially inflexible, and/or may be less flexible when compared to flexible joining regions 164. Rigid joining regions 166 may be formed from the same or a different material than the adjacent tooth-covering regions 110 and/or may have the same flexibility, hardness, and/or other properties as the adjacent tooth-covering regions 110.

With continued reference to FIGS. 1-2, and in some examples, dental arch 20 may include one or more regions with damaged, missing, maloccluded, and/or malformed teeth, as indicated at 54 in FIG. 1. In such examples, veneers 100 may include a filler region 180, which may take the place of at least a region, or even an entirety, of a damaged, missing, maloccluded, and/or malformed tooth 54 within dental arch 20. In some examples, filler region 180 may project in the lingual direction from the vestibular region 120 of the veneer to partially, if not completely, occupy a space between adjacent ones of an individual's teeth. In some examples, filler region 180 may include and/or be an at least partially, or even completely, tooth-shaped filler region 180.

Such a configuration may provide a number of benefits. As an example, filler region 180 may support a remainder of veneer 100, such as during chewing, thereby decreasing a potential for damage to the veneer due to the existence of damaged, missing, maloccluded, and/or malformed tooth 54.

As another example, the individual may desire to have damaged, missing, and/or malformed tooth 54 repaired and/or replaced, such as via a dental implant. Prior to receiving the dental implant, adjacent teeth within the individual's dental arch may tend to shift and/or move closer together. However, the presence of filler region 180 may retain the adjacent teeth in their original positions, may decrease a potential for shifting of the adjacent teeth, and/or maintain a desired gap between the adjacent teeth. This may permit the individual to obtain the dental implant at a later date while minimizing, or even eliminating, shifting of the adjacent teeth and additional complications that may be associated with such shifting.

Filler region 180 may have any suitable filler region shape. As an example, and when the individual is missing tooth 54, the filler region shape may correspond to a shape of the missing tooth. As another example, and when the individual has a damaged and/or malformed tooth 54, the filler region shape may correspond to a shape of a missing region of the tooth and/or to a supplemental region of the tooth that brings the tooth to a more desired shape.

It is within the scope of the present disclosure that filler region 180 may have any suitable extent and/or position, such as relative to gum 50 of dental arch 20. As an example, it may be desirable to avoid direct contact, or at least continuous direct contact, between the filler region and the gum and/or to avoid applying pressure to the gum, such as to decrease a potential for recession of the gum. In such examples, the filler region may be shaped to conform to a gum shape of the gum while maintaining a filler-gum separation distance from the gum. Examples of the filler-gum separation distance include at least 0.01 millimeters (mm), at least 0.02 mm, at least 0.04 mm, at least 0.06 mm, at least 0.08 mm, at least 0.1 mm, at least 0.2 mm, at most 0.5 mm, at most 0.4 mm, at most 0.3 mm, at most 0.2 mm, at most 0.1 mm, and/or at most 0.05 mm.

FIG. 3 illustrates an example of veneers 100 that includes eight tooth-covering regions 110. A single flexible joining region 164 is symmetrically positioned with four tooth-covering regions 110 extending on each side thereof. All other adjacent pairs of tooth-covering regions 110 are joined by corresponding rigid joining regions 166. Stated differently, veneer 100 of FIG. 3 may include a first pair of adjacent tooth-covering regions 110, which may be joined by a corresponding flexible joining region 164, and a plurality of second pairs of adjacent tooth-covering regions 110, which may be joined by corresponding rigid joining regions 166.

FIG. 4 illustrates another example of veneers 100 that includes eight tooth-covering regions 110. In FIG. 4, adjacent central tooth-covering regions 110 are joined by a corresponding rigid joining region 166, and each of these adjacent central tooth-covering regions 110 is then joined to a group of three additional tooth-covering regions 110 via a corresponding flexible joining region 164. Within each group of three additional tooth-covering regions 110, adjacent tooth-covering regions 110 are joined by corresponding rigid joining regions 166.

FIG. 5 illustrates another example of veneers 100 that includes eight tooth-covering regions 110. In FIG. 5, three flexible joining regions 164 are symmetrically distributed to join four pairs of tooth-covering regions 110, and each pair of tooth-covering regions 110 is joined by a corresponding rigid joining region 166.

FIG. 6 illustrates another example of veneers 100 that includes eight tooth-covering regions 110. In FIG. 6, all adjacent pairs of tooth-covering regions 110 are joined via corresponding flexible joining regions 164.

FIGS. 3-6 are illustrative examples, and it is within the scope of the present disclosure that veneers 100 may include any suitable number of tooth-covering regions 110 and any suitable corresponding number of joining regions 160, examples of which are disclosed herein. It is also within the scope of the present disclosure that a configuration for individual joining regions 160 (e.g., as flexible joining regions 164 or rigid joining regions 166) may be selected based upon any suitable criteria. As examples, the configuration of the individual joining regions 160 may be selected based, at least in part, on a desired degree of flexibility for veneers 100, on a desired level of comfort for the individual who utilizes veneers 100, and/or on a sensitivity of the individual's mouth to veneers 100 and/or to forces that are applied to the individual's teeth by veneers 100.

In some examples, veneers 100 may be retained on teeth 30 via a retention force that is at least partially, or even completely, generated by joining regions 160. As an example, and as illustrated in FIGS. 1-2, veneers 100 may be arcuate in shape, thereby extending around the dental arch, and engagement of individual tooth-covering regions 110 with individual teeth 30 may retain the veneers on the teeth. In some examples, veneers 100 may define an arch shape that is slightly smaller or more arcuate than the corresponding dental arch such that the distal end regions of the veneer are urged slightly away from each other, or deflect away from each other, when the veneer is installed on the dental arch. In such examples, the joining regions 160 may enable the veneer to resiliently and/or elastically deform during installation. In some examples, such as when at least a subset of tooth-covering regions 110 include both vestibular region 120 and lingual region 140, the lingual region and the vestibular region of a given tooth-covering region may be shaped such that the given tooth-covering region is deformed and/or deflected when the given tooth-covering region is installed on the corresponding tooth, thereby generating the retention force. As a more specific example, the lingual region and the vestibular region may be deflected away from each other to generate the retention force.

The above-described deflections and/or deformations of veneers 100 may result in the veneer being biased against the individual's teeth that are covered by the veneer, thereby causing the veneer to grip the individual's teeth, causing the veneer to impart the retention force on the individual's teeth, causing the veneer to impart the retention force on the individual's dental arch, and/or generating the retention force between the individual's teeth and the veneer. In such examples, separation of veneers 100 from the teeth may require that the individual overcome, or manually overcome, this retention force, and the configuration for individual tooth-joining regions 160 may be based, at least in part, on a desired magnitude and/or direction for this retention force.

As illustrated in dashed lines in FIGS. 1-2, and in solid lines in FIGS. 7 and 9-13, one or more tooth-covering regions 110 within veneers 100 may include an incisal region 130. Incisal region 130, when present, may extend from vestibular region 120 and along, at least partially along, across, and/or at least partially across an incisal surface 42 of a corresponding tooth 30, as illustrated in FIGS. 1, 7, 9-10, and 12. Stated differently, and when veneers 100 are temporarily attached to the target region of the individual's dental arch, incisal region 130 may at least partially, at least substantially, or even completely, define a biting surface for the corresponding tooth 30.

As illustrated in dashed lines in FIGS. 1-2 and in solid lines in FIGS. 7, 10-12, and 15, one or more tooth-covering regions 110 within veneers 100 also may include a lingual region 140. Lingual region 140, when present, may extend from incisal region 130 and along, at least partially along, across, and/or at least partially across a lingual surface 44 of a corresponding tooth 30, as illustrated in FIGS. 1, 7, 10, 12, and 15.

Incisal region 130 and/or lingual region 140, when present, additionally or alternatively may be utilized to assist with retention of veneers 100 on teeth 30. As an example, incisal region 130 may operatively interlock with incisal surface 42 to retain the veneer on the teeth. As another example, tooth 30 may be received within an opening and/or channel, which may be at least partially defined by the combination of vestibular region 120, incisal region 130, and lingual region 140, thereby retaining the veneer on the tooth.

In some examples, two adjacent tooth-covering regions 110 may include corresponding incisal regions 130 and lingual regions 140. In such a configuration, joining region 160 therebetween may be rigid, may be at least substantially rigid, and/or may exhibit less flexibility than desired for a particular veneer. With this in mind, such veneers 100 may include a relief region 170, examples of which are illustrated in FIGS. 1 and 11. Relief region 170 may include and/or be an opening and/or a recess within lingual region 140 and/or within joining region 160 that may extend toward and/or into incisal region 130 and/or that may extend across and/or through a thickness of the veneer. In the example of FIG. 11, relief region 170 may be triangular, or at least partially triangular, in shape and may taper toward incisal region 130. The relief region may be positioned at least partially, or even completely, within lingual region 140, may be positioned at least partially, or even completely, within joining region 160, and/or may be positioned at least partially, or even completely, between the adjacent pair of tooth-covering regions 110.

Relief region 170 may be configured to increase flexibility of veneer 100, such as may be relative to a corresponding veneer that does not include relief region 170. Additionally or alternatively, relief region 170 may be configured to facilitate temporary attachment of the veneer to the individual's dental arch, to facilitate intentional separation of the veneer from the individual's dental arch, and/or to increase the individual's comfort while utilizing the veneer, such as via increasing flexibility of the veneer in an incisal or a palatal direction when compared to the corresponding veneer that does not include relief region 170. Additionally or alternatively, relief region 170 may be configured to decrease stress concentrations within veneer 100, such as via providing increased flexibility and/or decreasing a potential for damage to lingual region 140 due to flexing of the veneer. Additionally or alternatively, relief region 170 may decrease a potential for formation of a vacuum seal between veneer 100 and teeth 30 and/or dental arch 20, such as via providing a pathway for fluid flow between the veneer and the teeth. Such a configuration may aid in and/or decrease separation forces needed during intentional separation of the veneer from the target region of the individual's dental arch.

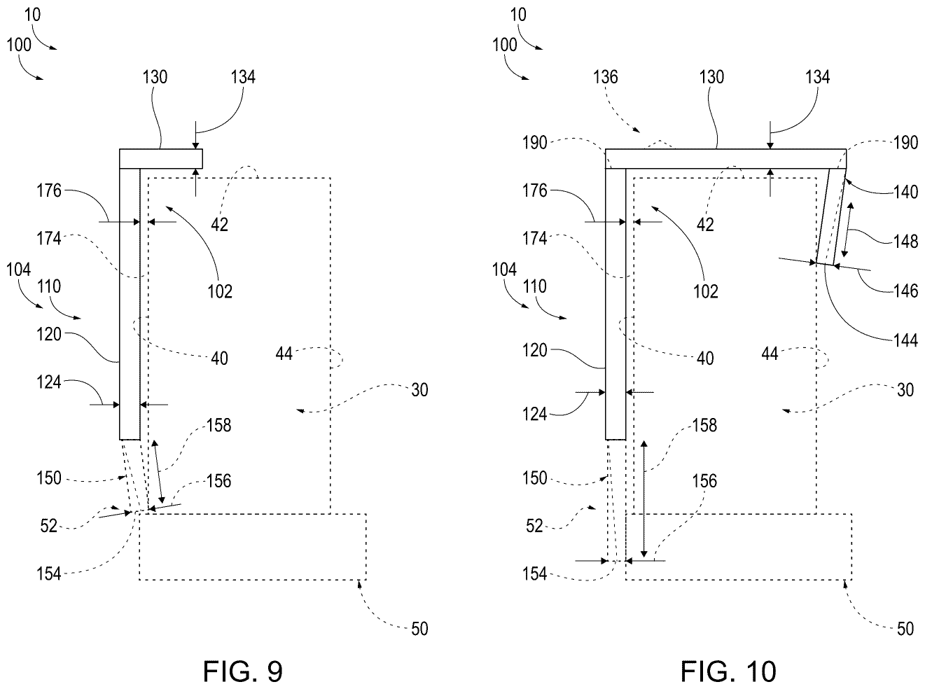

Turning to FIGS. 7-10, incisal region 130 of a given tooth-covering region 110 may extend any suitable distance, or may extend across any suitable fraction, of incisal surface 42 of tooth 30. As an example, and as illustrated in FIGS. 7 and 10, incisal region 130 may extend entirely across, or across an entirety of, incisal surface 42. As another example, and as illustrated in FIG. 9, incisal region 130 may extend partially across incisal surface 42, such as via extending across at least 10%, at least 20%, at least 30%, at least 40%, at least 50%, at least 60%, at least 70%, at most 90%, at most 80%, at most 70%, at most 60%, at most 50%, at most 40%, at most 30%, and/or at most 20% of the incisal surface. As another example, and as illustrated in FIG. 8, the given tooth-covering region 110 may not include incisal region 130 and/or may not extend across incisal surface 42 of tooth 30.

The plurality of corresponding teeth over which veneers 100 extend may include a number of teeth, which may be within a single dental arch 20 of the individual, and incisal region 130 may extend at least partially along incisal surface 42 of a subset, or of at least the subset, of the plurality of corresponding teeth. Stated differently, veneers 100 may include a number of tooth-covering regions 110 that correspond to, or equal, the number of teeth over which veneers 100 extend, and all tooth-covering regions 110 are not required to include incisal region 130. Stated still differently, a subset, or at least the subset, of the plurality of tooth-covering regions 110 may include incisal region 130, and this subset of the plurality of tooth-covering regions may, in some examples, be fewer than a total number of tooth-covering regions in veneers 100.

In specific examples, incisal region 130 may be present, or only may be present, in a given tooth-covering region 110 when needed to facilitate retention of veneers 100 on teeth 30 and/or when needed to repair and/or improve functionality of a given tooth. Such a configuration may facilitate and/or improve adoption of veneers 100 by the individual, may improve comfort when utilizing veneers 100, may limit, or decrease, interference of veneers 100 with the individual's speech, and/or may limit, or decrease, interference of veneers 100 with the individual's ability to chew.

Examples of the subset of the plurality of corresponding teeth include at least 14 fewer teeth than the number of teeth, at least 12 fewer teeth than the number of teeth, at least 10 fewer teeth than the number of teeth; at least 8 fewer teeth than the number of teeth, at least 6 fewer teeth than the number of teeth, at least 4 fewer teeth than the number of teeth, at least 2 fewer teeth than the number of teeth, at most the number of teeth, at most 2 fewer than the number of teeth, at most 4 fewer than the number of teeth, at most 6 fewer than the number of teeth, at most 8 fewer than the number of teeth, at most 10 fewer than the number of teeth, at most 12 fewer than the number of teeth, and/or at most 14 fewer than the number of teeth. Additional examples of the subset of the plurality of teeth include at least 2 teeth, at least 3 teeth, at least 4 teeth, at least 5 teeth, at least 6 teeth, at least 7 teeth, at least 8 teeth, at least 9 teeth, at least 10 teeth, at least 11 teeth, at least 12 teeth, at least 13 teeth, at least 14 teeth, at least 15 teeth, at most 16 teeth, at most 15 teeth, at most 14 teeth, at most 13 teeth, at most 12 teeth, at most 11 teeth, at most 10 teeth, at most 9 teeth, at most 8 teeth, at most 7 teeth, at most 6 teeth, at most 5 teeth, at most 4 teeth, at most 3 teeth, and/or at most 2 teeth.

In some examples, the subset of the plurality of corresponding teeth may exclude at least one, and optionally all, incisors, at least one, and optionally all, canines, and/or at least one, and optionally all, premolars. Additionally or alternatively, the subset of the plurality of corresponding teeth may include at least one, and optionally all, molars, at least one, and optionally all, premolars, and/or at least one, and optionally all, canines. In a specific example, incisal region 130 may be present, or only may be present, in tooth-covering regions 110 that have only a single adjacent tooth-covering region 110 (e.g., at the extremities and/or ends of veneers 100). In another specific example, an extent to which incisal region 130 extends along incisal surface 42 of at least one tooth 30 may differ from an extent to which the incisal region extends along the incisal surface of at least one other tooth.

Similarly, an extent to which lingual region 140 extends along lingual surface 44 of at least one tooth 30 may differ from an extent to which the lingual region extends along the lingual surface of at least one other tooth. This is illustrated in the example of FIG. 15, where lingual region 140 extends along approximately 20% of lingual surface 44 of canine teeth 36 but only across approximately 10% of lingual surface 44 of incisor teeth 38. Additional examples include lingual region 140 extending along at least 10%, at least 15%, at least 20%, at least 25%, at least 30%, at least 40%, at most 50%, at most 40%, at most 30%, and/or at most 20% of lingual surface 44 of at least one or more of the teeth, such as canine teeth, and lingual region 140 extending along none, at least 2%, at least 5%, at least 10%, at least 15%, at least 20%, at most 30%, at most 20%, at most 10%, and/or at most 5% of lingual surface 44 of other teeth, such as incisor teeth.

With continued reference to FIGS. 7-10, and in some examples, veneers 100 and/or tooth-covering regions 110 thereof may include a constant, or at least substantially constant, vestibular region thickness 124 and/or incisal region thickness 134, which may be selected to provide one or more desired properties to veneers 100, such as a desired durability, a desired rigidity, a desired opacity, and/or a desired color. Examples of the vestibular region thickness and/or of the incisal region thickness include at least 0.1 millimeters (mm), at least 0.2 mm, at least 0.3 mm, at least 0.4 mm, at least 0.5 mm, at least 0.6 mm, at least 0.7 mm, at least 0.8 mm, at least 0.9 mm, at least 1 mm, at most 2 mm, at most 1.8 mm, at most 1.6 mm, at most 1.4 mm, at most 1.2 mm, at most 1 mm, at most 0.9 mm, at most 0.8 mm, at most 0.7 mm, at most 0.6 mm, at most 0.5 mm, at most 0.4 mm, or at most 0.3 mm.

However, a thickness of the extremities, edges, margins, and/or external perimeter of veneers 100 and/or of tooth-covering regions 110 thereof may be less than vestibular region thickness 124 and/or less than incisal region thickness 134. Such a configuration may improve the individual's comfort when utilizing veneers 100, such as via decreasing a likelihood of the individual's lip and/or tongue to drag and/or catch on veneers 100. Such a configuration additionally or alternatively may reduce a potential for the individual's speech to be impaired or altered by veneer 100, such as due to movement of the individual's tongue and/or lips being obstructed, hindered, or otherwise impaired by contact with veneer 100. Additionally or alternatively, such a configuration may provide a more natural look for veneers 100, may provide a flush, seamless, and/or inconspicuous transition between veneers 100 and the individual's gum, and/or may enhance aesthetics.

This may be accomplished in any suitable manner. As an example, veneers 100 and/or tooth-covering regions 110 thereof may include a gum-proximate region 150. Gum-proximate region 150 may extend from tooth-covering regions 110, may extend between tooth-covering regions 110 and a gum 50 of dental arch 20, and/or may extend between vestibular regions 120 of tooth-covering regions 110 and gum 50. In such a configuration, and as illustrated in FIGS. 7-10, gum-proximate region 150 may taper from vestibular region thickness 124 to a gum-proximate edge 154, which may define a gum-proximate edge thickness 156 that may be less than the vestibular region thickness. Examples of the gum-proximate edge thickness include at least 0.05 mm, at least 0.1 mm, at least 0.15 mm, at least 0.2 mm, at least 0.25 mm, at least 0.3 mm, at least 0.35 mm, at least 0.4 mm, at least 0.45 mm, at least 0.5 mm, at least 0.55 mm, at least 0.6 mm, at most 0.9 mm, at most 0.8 mm, at most 0.7 mm, at most 0.6 mm, at most 0.5 mm, at most 0.4 mm, and/or at most 0.3 mm. Examples of a ratio of the gum-proximate edge thickness to the vestibular region thickness include at least 0.15, at least 0.2, at least 0.25, at least 0.3, at least 0.35, at least 0.4, at least 0.45, at least 0.5, at least 0.55, at least 0.6, at most 0.9, at most 0.85, at most 0.8, at most 0.75, at most 0.7, at most 0.65, at most 0.6, at most 0.55, at most 0.5, at most 0.45, at most 0.4, at most 0.35, at most 0.3, at most 0.25, at most 0.2, at most 0.15, and/or at most 0.1.

Gum-proximate region 150 may taper toward tooth 30 and/or gum 50. Additionally or alternatively, the gum-proximate region may taper, or may monotonically taper, along, or along an entirety of, a gum-proximate edge region taper length 158. Examples of the gum-proximate edge region taper length include at least 0.5 mm, at least 0.75 mm, at least 1 mm, at least 1.25 mm, at least 1.5 mm, at least 1.75 mm, at least 2 mm, at most 4 mm, at most 3.75 mm, at most 3.5 mm, at most 3.25 mm, at most 3 mm, at most 2.75 mm, at most 2.5 mm, at most 2.25 mm, and/or at most 2 mm.

As another example, and when veneers 100 and/or tooth-covering regions 110 thereof include lingual region 140, the lingual region may taper from incisal region thickness 134 to a lingual region edge 144, which may define a lingual region edge thickness 146 that may be less than the incisal region thickness. Examples of the lingual region edge thickness are disclosed herein with reference to gum-proximate edge thickness 156. Examples of a ratio of the lingual region edge thickness to the incisal region thickness are disclosed herein with reference to the ratio of the gum-proximate edge thickness to the vestibular region thickness. Lingual region 140 may taper toward tooth 30 and/or gum 50. Additionally or alternatively, lingual region 140 may taper, or may monotonically taper, along, or along an entirety of, a lingual region taper length 148, examples of which are disclosed herein with reference to gum-proximate edge region taper length 158.

The above-described taper within gum-proximate region 150 and/or within lingual region 140 may provide several distinct benefits. As an example, the taper within gum-proximate region 150 may decrease a potential for veneers 100 to catch and/or drag on the individual's lip when the individual smiles, opens their mouth, installs the veneers within their dental arch, and/or removes the veneers from their dental arch. Stated differently, the taper within the gum-proximate region may permit and/or facilitate a more natural smile, more comfortable installation of the veneers, and/or more comfortable removal of the veneers than otherwise would be possible without the presence of the taper within the gum-proximate region. As another example, the taper within lingual region 140 may decrease a potential for the individual's tongue to catch and/or drag on veneers 100 during speech. Stated differently, the taper within the lingual region may permit and/or facilitate more natural speech than otherwise would be possible without the presence of the taper within the lingual region.

Veneers 100 and/or tooth-covering regions 110 thereof may define a tooth-facing side 102, which may be opposite and/or opposed to outward-facing side 104, may face toward, or contact, teeth 30, and/or may face toward, or contact, dental arch 20. In some examples, veneers 100 may be shaped, sized, and/or configured to maintain a gap 174 between teeth 30 and at least a fraction of tooth-facing side 102, as illustrated in FIGS. 7-10 and 12. Such a configuration may improve retention of veneers 100 on teeth 30, may decrease a potential for entrapment of liquids and/or debris between the veneers and the teeth, and/or may decrease a potential for hygiene issues.

To facilitate attachment of veneers 100 to teeth 30 and/or retention of veneers 100 on teeth 30, the fraction of tooth-facing side 102 that includes gap 174 may be less than an entirety of the tooth-facing side. Examples of the fraction of the tooth-facing side include at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at most 99%, at most 95%, at most 90%, at most 85%, at most 80%, at most 75%, at most 70%, at most 65%, at most 60%, at most 55%, and/or at most 50%. As specific examples, the fraction of the tooth-facing side may exclude gum-proximate edge 154, at least a region of the gum-proximate edge, and/or an entirety of the gum-proximate edge. As additional specific examples, the fraction of the tooth-facing side may exclude lingual region edge 144, at least a region of the lingual region edge, and/or an entirety of the lingual region edge.

Gap 174 may have and/or define any suitable gap width 176. Examples of the gap width include at least 0.005 mm, at least 0.01 mm, at least 0.015 mm, at least 0.02 mm, at least 0.025 mm, at least 0.3 mm, at least 0.35 mm, at least 0.4 mm, at most 0.05 mm, at most 0.045 mm, at most 0.04 mm, at most 0.035 mm, at most 0.03 mm, at most 0.025 mm, and/or at most 0.02 mm. In some examples, there is no, or no purposeful, gap between teeth 30 and tooth-facing side 102.

In some examples, veneers 100 may include and/or be composite veneers 100, which also may be referred to herein as composite customized temporary veneers 100. Composite veneers 100 may be defined by and/or may include a plurality of different materials, a plurality of different material regions, and/or a plurality of assembled components. As an example, vestibular region 120 may be formed from and/or defined by a vestibular region material and joining region 160 may be formed from and/or defined by a joining region material. Similarly, incisal region 130 may be formed from and/or defined by an incisal region material, lingual region 140 may be formed from and/or defined by a lingual region material, and/or gum-proximate region 150 may be formed from and/or defined by a gum-proximate region material.

In such a configuration, at least one of these materials may differ from at least one other of these materials. As examples, the vestibular region material may differ from the joining region material, from the incisal region material, from the lingual region material, and/or from the gum-proximate region material. As additional examples, the joining region material may differ from the incisal region material, from the lingual region material, and/or from the gum-proximate region material. As additional examples, the lingual region material may differ from the incisal region material and/or from the gum-proximate region material. As another example, the incisal region material may differ from the gum-proximate region material.

The various materials of veneers 100 may differ from one another in any suitable manner. As an example, the incisal region material may define a greater hardness than the joining region material, the lingual region material, the vestibular region material, and/or the gum-proximate region material. Such a configuration may increase durability of the incisal region when utilized for chewing.

As another example, the joining region material may define a greater flexibility than the incisal region material, the lingual region material, the vestibular region material, and/or the gum-proximate region material. Such a configuration may increase the individual's comfort when the veneers are utilized and/or may facilitate attachment and/or disengagement of the veneers from the individual's teeth.

As yet another example, the vestibular region material may have a different aesthetic, color, and/or opacity than the incisal region material, the joining region material, the lingual region material, and/or the gum-proximate region material. Such a configuration may impart a more natural, or otherwise desired, appearance to the individual's mouth, such as by utilizing a vestibular region material with a color selected to mimic the individual's teeth, or a desired color for the individual's teeth.

As another example, the gum-proximate region material may have a different aesthetic, color, and/or opacity than the incisal region material, the joining region material, the lingual region material, and/or the vestibular region material. Such a configuration may provide a more natural transition between veneers 100 and the individual's gums, such as by utilizing a gum-proximate region material with a color selected to mimic the individual's gums and/or permitting gum recession to be covered by veneers 100. In some examples, the gum-proximate material region may be formed from a material that is softer and/or less likely to irritate the individual's gums than the incisal region material, the lingual region material, and/or the vestibular region material.

In some examples, veneers 100 may define an abrupt, or a step, transition between two or more materials. As examples, the abrupt transition may be between the vestibular region material and the joining region material, the incisal region material, the lingual region material, and/or the gum-proximate region material. As additional examples, the abrupt transition may be between the joining region material and the incisal region material, the lingual region material, and/or the gum-proximate region material. As additional examples, the abrupt transition may be between the lingual region material and the incisal region material and/or the gum-proximate region material. As another example, the abrupt transition may be between the incisal region material and the gum-proximate region material.

In some examples, veneers 100 may define a gradual, or gradient, transition between two or more materials. As examples, the gradual transition may be between the vestibular region material and the joining region material, the incisal region material, the lingual region material, and/or the gum-proximate region material. As additional examples, the gradual transition may be between the joining region material and the incisal region material, the lingual region material, and/or the gum-proximate region material. As additional examples, the gradual transition may be between the lingual region material and the incisal region material and/or the gum-proximate region material. As another example, the gradual transition may be between the incisal region material and the gum-proximate region material.

As illustrated in FIGS. 1-2, 7, and 14, veneers 100 may include an interlock structure 190. Interlock structure 190, when present, may extend between, interconnect, and/or interlock two or more components of composite veneers 100, such as to decrease a potential for separation of the two or more components of composite veneers 100 and/or to provide a desired mechanical interconnection between the two or more components of composite veneers 100. In some examples, interlock structure 190 may be at least partially, or even completely, defined by, or may define at least one, or even both, of the two or more components of composite veneers 100. In other examples, interlock structure 190 may be a separate component.

Examples of interlock structure 190 include a region of increased surface area, a zipper-shaped structure, a rounded zipper-shaped structure, a wavy region, a zigzag region, a sawtooth region, and/or a hinge. Examples of the two or more components of composite veneers 100 include tooth-covering region 110, vestibular region 120, incisal region 130, lingual region 140, gum-proximate region 150, and/or joining region 160. When interlock structure 190 is utilized to interconnect adjacent tooth-covering regions 110, the interlock structure may at least partially define, may completely define, and/or may be joining region 160. In some such examples, the joining region may include an entirety of the interlock structure and/or the interlock structure may define an entirety of the joining region. Alternatively, and in some such examples, the joining region may include one or more components and/or regions that are external the interlock structure and/or the interlock structure may include one or more components and/or regions that are external the joining region.

Inclusion of interlock structure 190 within composite veneers 100 may increase bond strength between the two or more components of composite veneers 100 and/or may distribute loads and/or forces between the two or more components of composite veneers 100. Additionally or alternatively, inclusion of interlock structure 190 may avoid direct application of loads in peel and/or in sheer to an interface between the two or more components of composite veneers 100 and/or may provide a more durable and/or reliable connection between the two or more components of composite veneers 100.

In some examples, veneers 100 may include a surface treatment 192, as illustrated in FIGS. 1-2. Surface treatment 192, when present, may be selected and/or applied to modify, or to locally modify, at least one property of veneers 100. As an example, the surface treatment may be utilized to modify an aesthetic property of the veneer, such as via modification of a color, a shade, and/or an opacity of the veneer. As another example, the surface treatment may be utilized to modify a mechanical property of the veneer, such as a flexibility, a stiffness, and/or a smoothness of the veneer. Examples of the surface treatment include a polished region, a glazed region, and/or a coated region of veneers 100.

In some examples, veneers 100 may include colorants. Such colorants may be utilized to provide a more natural appearance for veneers 100. In some examples, the colorants, or a concentration of the colorants, may vary across a surface of veneers 100, such as to provide visual depth for an embrasure region between adjacent tooth-covering regions 110 and/or to provide a more natural transition to gums 50, as is discussed in more detail herein.

As discussed herein with reference to FIGS. 7-10, veneers 100 may include gum-proximate region 150. In some examples, and as illustrated in FIGS. 7-9, veneers 100 and/or gum-proximate region 150 may be configured to extend to gums 50 and/or to a gumline 52 between teeth 30 and gums 50. Such a configuration may provide a more natural look for veneers 100 when temporarily attached to the individual's dental arch.

In some examples, and as illustrated in FIG. 10, veneers 100 and/or gum-proximate region 150 thereof may be configured to extend over, and/or to cover gumline 52. Stated differently, gum-proximate region 150 may at least partially overlap with gums 50. Such a configuration may provide several benefits. As an example, veneers 100 may, or may be utilized to, protect gums 50 and/or gumline 52. As another example, veneers 100 may, or may be utilized to, cover recession within and/or of gumline 52.

In some examples, veneers 100 and/or gum-proximate region 150 thereof may press against and/or contact gums 50, as illustrated in FIG. 10. Stated differently, at least a region of veneers 100 and/or of gum-proximate region 150 may directly contact gums 50 and/or may exert a contact force on the gums. Such a configuration may provide several benefits. As an example, contact between veneers 100 and gums 50 may slow and/or stop gum growth up and/or around teeth 30, may slow and/or stop gum growth toward incisal surface 42 of teeth 30, and/or may encourage recession of gums 50. As another example, contact between veneers 100 and gums 50 may slow and/or prevent regrowth of the gums subsequent to partial gum removal as part of a surgical crown lengthening procedure. As another example, contact between veneers 100 and gums 50 may encourage the gums to recede, thereby providing an alternative to the surgical crown lengthening procedure. As another example, gum-proximate region 150 may be shaped to encourage gums 50 and/or gumline 52 to take on and/or to exhibit a desired shape and/or position within the dental arch.

In some examples, veneers 100 and/or gum-proximate region 150 thereof may extend at least partially over, or overlap with, gums 50 and/or may cover gumline 52, while still being spaced apart from such gums 50 and/or gumline 52, as illustrated in dashed lines in FIGS. 7-9 and in dotted lines in FIG. 10. Stated differently, veneers 100 and/or gum-proximate region 150 may be proximate gums 50 and/or may appear to cover and/or contact gums 50 when viewed from outside the individual's mouth; however, the veneers may not contact at least a region of the gums and/or of the gumline and/or may maintain a separation distance from the region of the gums and/or of the gumline. Such a configuration may provide several benefits. As an example, the space between the veneers and the gumline may permit fluid to flow therebetween, which may decrease the potential for formation of the vacuum seal between the veneers and dental arch 20. As another example, the space may permit, may encourage, and/or may stimulate gum growth up and/or around teeth 30 and/or toward incisal surface 42 of the teeth. As another example, the space may discourage recession of the gums.

In some examples, veneers 100 may be configured such that gum-contacting portions of gum-proximate region 150 press against and/or contact gums 50, while gum-spaced portions of the gum-proximate region are spaced apart from gums 50. Such a configuration may provide several benefits. As an example, the gums may be encouraged to grow up and/or around the teeth within the gum-spaced portions. As another example, the gums may be discouraged from growing up and/or around the teeth within the gum-contacting portions. As another example, selection of the location and/or extent of the gum-contacting portions and the gum-spaced portions may be utilized to direct and/or change the shape of gumline 52, such as to a desired gumline shape.

In some examples, and as discussed in more detail herein, gum-proximate region 150 may be at least partially colored to match a color of gums 50. Such a configuration may provide several benefits. As an example, the coloration of the gum-proximate region may be utilized to provide a desired aesthetic for dental arch 20. As another example, the coloration of the gum-proximate region, or the extent of the coloration along teeth 30 and/or toward incisal surface 42 may be utilized to modify a visual appearance of a length of teeth 30, thereby providing an aesthetic alternative to the surgical crown lengthening procedure.

Gum-proximate region 150 may include and/or be any suitable portion, fraction, and/or region of veneers 100 that extends from tooth-covering regions 110, that is an extension of tooth-covering regions 110, that is proximate gum 50 relative to tooth-covering regions 110, and/or that defines gum-proximate edge 154. In some examples, gum-proximate region 150 may include and/or be a portion and/or region of veneers 100 that includes gum-proximate edge 154, that tapers toward gum-proximate edge 154, and/or that extends within gum-proximate edge region taper length 158, as illustrated in FIGS. 7-10. In some examples, gum-proximate region 150 may include and/or be a portion and/or region of veneers 100 that is at least partially formed and/or defined by the gum-proximate region material, which may differ from one or more other materials of veneers 100, as discussed in more detail herein. In some such examples, the gum-proximate region material may be relatively softer than the vestibular region material, thereby decreasing a potential for irritation of the individual's gums. In some examples, gum-proximate region 150 may include and/or be a portion and/or region of veneers 100 that includes the different aesthetic, color, and/or opacity compared to the incisal region, the joining region, the lingual region, and/or the vestibular region. In some such examples, gum-proximate region 150 may include a portion and/or region of veneers 100 that is colored to match the individual's gums and/or that extends from an artificial gumline between the vestibular region and the gum-proximate region. It is within the scope of the present disclosure that at least a subset, or even all, of gum-proximate region 150 may extend over, only over, across, and/or only across the individual's teeth, as illustrated in FIGS. 7-9. Additionally or alternatively, at least a subset, or even all, of gum-proximate region 150 may extend over, only over, across, and/or only across the individual's gums, as illustrated in FIG. 10. It may be beneficial to support veneers 100, when detached from the individual's dental arch, in a manner that decreases a potential for stress to the veneers and/or deformation of the veneers. With this in mind, and in some examples, veneers 100 may include a support structure 200, as illustrated in FIG. 1. Support structure 200, when present, may have a support structure shape that corresponds to, or matches, a shape of the individual's dental arch. As such, support structure 200 may support veneers 100 in a manner that is similar to how the veneers are supported by the individual's dental arch. With this in mind, any of the forces, interactions, overlaps, and/or spatial relationships that are disclosed herein as being between the individual's dental arch and veneers 100 also may be described as being between support structure 200 and veneers 100.

As discussed in more detail herein, veneers 100 may be retained on teeth 30 via a retention force that is generated by veneers 100, by the interface between veneers 100 and teeth 30, and/or by at least partial interlocking between the veneers and the teeth. With this in mind, and in some examples, veneers 100 may be temporarily attached to the individual's dental arch without a permanent adhesive attachment to the target region of the individual's dental arch, with only a temporary adhesive attachment to the target region of the individual's dental arch, or without any adhesive attachment to the target region of the individual's dental arch. Additionally or alternatively, veneers 100 may be configured to be temporarily attached to the target region of the individual's dental arch without a bone mount to the target region of the individual's dental arch and/or without other modification to the individual's dental arch. Additionally or alternatively, veneers 100 may be configured to be temporarily attached to the target region of the individual's dental arch without reshaping or removal of dental material from the individual's dental arch and/or from the individual's teeth.

As discussed, and in some examples, veneers 100 and/or tooth-covering regions 110 thereof may include incisal region 130. In some such examples, at least a portion of an exposed incisal surface of incisal region 130 may be relatively sharper than a corresponding incisal surface 42 along which the incisal region extends. This is illustrated in FIGS. 7 and 10 and indicated at 136. Such a configuration may provide the individual's teeth with improved cutting, biting, and/or chewing characteristics when veneers 100 are temporarily attached to the target region of the individual's dental arch.

In some examples, veneers 100 may be configured to deliver a medication to mouth 10, to dental arch 20, to teeth 30, and/or to gums 50. As an example, veneers 100 may be infused with the medication and/or may release the medication upon being positioned on the dental arch, as indicated at 60 in FIGS. 1-2. Additionally or alternatively, veneers 100 may include a medication reservoir 62, which may contain the medication and/or may be configured to release the medication when the veneers are positioned on the dental arch. Such a configuration may provide several benefits. As an example, regular utilization of veneers 100 may permit and/or facilitate regular treatment of mouth 10, dental arch 20, teeth 30, and/or gums 50 with the medication. As a more specific example, and subsequent to the surgical crown lengthening procedure, veneers 100 may deliver medication, such as antibiotic and/or antimicrobial agents, within mouth 10 and/or directly to gums 50, thereby decreasing a potential for infection subsequent to the surgical crown lengthening procedure.

It is within the scope of the present disclosure that veneers 100 may be formed and/or defined in any suitable manner. As an example, at least a portion of veneers 100 may be 3D printed and/or may be defined utilizing a 3D printing technology. Examples of the 3D printing technology include lithographic and/or inkjet-based 3D printing technologies. As another example, veneers 100 may be formed utilizing a conventional, or a subtractive, machining technology, such as a computer numerical control (CNC) machining technology.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

Illustrative, non-exclusive examples of customized temporary veneers according to the present disclosure are presented in the following enumerated paragraphs.
A1. A customized temporary veneer configured to be temporarily attached to a target region of an individual's dental arch, the customized temporary veneer comprising:
a plurality of tooth-covering regions, wherein each tooth-covering region of the plurality of tooth-covering regions includes a corresponding vestibular region configured to at least partially, at least substantially, or even completely, cover a vestibular surface of a corresponding tooth of a plurality of corresponding teeth of the dental arch; and
at least one joining region that operatively attaches a pair of adjacent tooth-covering regions of the plurality of tooth-covering regions to one another.
A2. The customized temporary veneer of paragraph A1, wherein at least one of the customized temporary veneer, an entirety of the customized temporary veneer, the plurality of tooth-covering regions, and the at least one joining region is at least partially, at least substantially, or even completely, defined by a flexible polymeric material.
A3. The customized temporary veneer of paragraph A2, wherein the flexible polymeric material includes, or is, at least one of a polymeric resin, an epoxy, and a dental resin.
A4. The customized temporary veneer of any of paragraphs A2-A3, wherein the flexible polymeric resin is a biocompatible flexible polymeric resin.
A5. The customized temporary veneer of any of paragraphs A2-A4, wherein the flexible polymeric material defines a flexural strength of at least one of:
(i) at least 50 megapascals (MPa), at least 52 MPa, at least 54 MPa, at least 56 MPa, at least 58 MPa, at least 60 MPa, at least 62 MPa, at least 64 MPa, at least 66 MPa, or at least 68 MPa; and
(ii) at most 76 MPa, at most 74 MPa, at most 72 MPa, at most 70 MPa, at most 68 MPa, at most 66 MPa, at most 64 MPa, at most 62 MPa, or at most 60 MPa.
A6. The customized temporary veneer of any of paragraphs A2-A5, wherein the flexible polymeric material defines a flexural modulus of at least one of:
(i) at least 1300 MPa, at least 1350 MPa, at least 1400 MPa, at least 1450 MPa, at least 1500 MPa, at least 1550 MPa, at least 1600 MPa, at least 1650 MPa, or at least 1700 MPa; and
(ii) at most 1900 MPa, at most 1850 MPa, at most 1800 MPa, at most 1750 MPa, at most 1700 MPa, at most 1650 MPa, or at most 1600 MPa.
A7. The customized temporary veneer of any of paragraphs A2-A6, wherein the flexible polymeric material defines an elongation at break of at least one of:
(i) at least 10%, at least 15%, at least 20%, at least 25%, at least 30%, at least 35%, at least 40%, at least 45%, at least 50%, at least 55%, or at least 60%; and
(ii) at most 70%, at most 65%, at most 60%, at most 55%, at most 50%, at most 45%, at most 40%, or at most 35%.
A8. The customized temporary veneer of any of paragraphs A2-A7, wherein the flexible polymeric material defines a Shore D Hardness of at least one of:
(i) at least 70D, at least 72D, at least 74D, at least 76D, at least 78D, or at least 80D; and
(ii) at most 90D, at most 88D, at most 86D, at most 84D, at most 82D, or at most 80D.
A9 The customized temporary veneer of any of paragraphs A2-A8, wherein the flexible polymeric material defines a water sorption of at least one of:
(i) at least 6 micrograms per cubic millimeter (ug/mm³), at least 8 ug/mm³, at least 10 ug/mm³, at least 12 ug/mm³, or at least 14 ug/mm³; and
(ii) at most 35 ug/mm³, at most 30 ug/mm³, at most 25 ug/mm³, at most 20 ug/mm³, at most 15 ug/mm³, or at most 10 ug/mm³.
A10. The customized temporary veneer of any of paragraphs A2-A9, wherein the flexible polymeric material defines a water solubility of at least one of:
(i) at least 0.5 ug/mm³, at least 0.75 ug/mm³, at least 1 ug/mm³, at least 1.25 ug/mm³, at least 1.5 ug/mm³, or at least 2 ug/mm³; and
(ii) at most 6 ug/mm³, at most 5.5 ug/mm³, at most 5 ug/mm³, at most 4.5 ug/mm³, at most 4 ug/mm³, at most 3.5 ug/mm³, at most 3 ug/mm³, at most 2.5 ug/mm³, at most 2 ug/mm³, at most 1.5 ug/mm³, or at most 1 ug/mm³.
A11. The customized temporary veneer of any of paragraphs A1-A10, wherein the at least one joining region includes a flexible joining region that is at least partially, at least substantially, or even completely, defined by a/the flexible polymeric material.
A12. The customized temporary veneer of paragraph A11, wherein the flexible joining region defines a living hinge mechanism between the adjacent tooth-covering regions.
A13. The customized temporary veneer of any of paragraphs A11-A12, wherein the pair of adjacent tooth-covering regions is a first pair of adjacent tooth-covering regions, wherein the plurality of tooth-covering regions further includes a second pair of adjacent tooth-covering regions, and further wherein the at least one joining region includes a rigid, or at least substantially rigid, joining region that operatively attaches the second pair of adjacent tooth-covering regions.
A14. The customized temporary veneer of any of paragraphs A2-A13, wherein the flexible polymeric material is selected to provide a desired level of comfort for the individual.
A15. The customized temporary veneer of any of paragraphs A1-A14, wherein the customized temporary veneer includes a relief region optionally configured to at least one of:
(i) increase flexibility of the customized temporary veneer;
(ii) facilitate temporary attachment of the customized temporary veneer to the individual's dental arch;
(iii) facilitate separation of the customized temporary veneer from the individual's dental arch;
(iv) decrease stress concentrations within the customized temporary veneer;
(v) decrease potential for a vacuum seal between the customized temporary veneer and the individual's dental arch; and
(vi) increase the individual's comfort.
A16. The customized temporary veneer of paragraph A15, wherein the relief region includes a recess that extends across a thickness of the customized temporary veneer.
A17. The customized temporary veneer of any of paragraphs A15-A16, wherein the relief region is positioned in a lingual region of the customized temporary veneer, wherein the lingual region extends from an incisal region of the customized temporary veneer and is configured to extend at least partially along a lingual surface of at least a subset of the plurality of corresponding teeth.
A18. The customized temporary veneer of any of paragraphs A15-A17, wherein the relief region at least one of:
(i) is positioned at least partially, or even completely, between the pair of adjacent tooth-covering regions; and
(ii) is at least partially defined by the at least one joining region.
A19. The customized temporary veneer of any of paragraphs A1-A18, wherein at least a subset of the plurality of tooth-covering regions further includes an/the incisal region that extends from the vestibular region and at least partially along an incisal surface of at least a subset of the plurality of corresponding teeth.
A20. The customized temporary veneer of paragraph A19, wherein the plurality of corresponding teeth includes a number of teeth, optionally within a single dental arch of the individual, and further wherein the subset of the plurality of corresponding teeth includes at least one of:
(i) at least 14 fewer teeth than the number of teeth, at least 12 fewer teeth than the number of teeth, at least 10 fewer teeth than the number of teeth; at least 8 fewer teeth than the number of teeth, at least 6 fewer teeth than the number of teeth, at least 4 fewer teeth than the number of teeth, or at least 2 fewer teeth than the number of teeth; and
(ii) at most the number of teeth, at most 2 fewer than the number of teeth, at most 4 fewer than the number of teeth, at most 6 fewer than the number of teeth, at most 8 fewer than the number of teeth, at most 10 fewer than the number of teeth, at most 12 fewer than the number of teeth, or at most 14 fewer than the number of teeth.
A21. The customized temporary veneer of any of paragraphs A19-A20, wherein the subset of the plurality of corresponding teeth includes at least one of:
(i) at least 2 teeth, at least 3 teeth, at least 4 teeth, at least 5 teeth, at least 6 teeth, at least 7 teeth, at least 8 teeth, at least 9 teeth, at least 10 teeth, at least 11 teeth, at least 12 teeth, at least 13 teeth, or at least 14 teeth; and
(ii) at most 16 teeth, at most 15 teeth, at most 14 teeth, at most 13 teeth, at most 12 teeth, at most 11 teeth, at most 10 teeth, at most 9 teeth, at most 8 teeth, at most 7 teeth, at most 6 teeth, at most 5 teeth, at most 4 teeth, at most 3 teeth, or at most 2 teeth.
A22. The customized temporary veneer of any of paragraphs A19-A21, wherein the subset of the plurality of corresponding teeth excludes at least one of:
(i) at least one, and optionally all, incisors;
(ii) at least one, and optionally all, canines; and
(iii) at least one, and optionally all, premolars.
A23. The customized temporary veneer of any of paragraphs A19-A22, wherein the subset of the plurality of corresponding teeth includes at least one of:
(i) at least one, and optionally all, molars;
(ii) at least one, and optionally all, premolars; and
(iii) at least one, and optionally all, canines.
A24. The customized temporary veneer of any of paragraphs A19-A23, wherein an extent to which the incisal region extends along the incisal surface of at least one tooth in the subset of the plurality of corresponding teeth differs from an extent to which the incisal region extends along the incisal surface of at least one other tooth in the subset of the plurality of corresponding teeth.
A25. The customized temporary veneer of any of paragraphs A19-A24, wherein a fraction of the incisal surface of at least one tooth in the subset of the plurality of corresponding teeth that is covered by the incisal region differs from a fraction of the incisal surface of at least one other tooth in the subset of the plurality of corresponding teeth that is covered by the incisal region.
A26. The customized temporary veneer of any of paragraphs A1-A25, wherein the customized temporary veneer further includes a gum-proximate region that extends from the plurality of tooth-covering regions and is configured to extend at least partially between the plurality of tooth-covering regions and a gum of the individual's dental arch.
A27. The customized temporary veneer of paragraph A26, wherein the corresponding vestibular region defines a vestibular region thickness, and further wherein the gum-proximate region tapers from the vestibular region thickness to a gum-proximate edge that defines a gum-proximate edge thickness.
A28. The customized temporary veneer of paragraph A27, wherein the vestibular region thickness is at least one of:
(i) at least 0.1 millimeters (mm), at least 0.2 mm, at least 0.3 mm, at least 0.4 mm, at least 0.5 mm, at least 0.6 mm, at least 0.7 mm, at least 0.8 mm, at least 0.9 mm, or at least 1 mm; and
(ii) at most 2 mm, at most 1.8 mm, at most 1.6 mm, at most 1.4 mm, at most 1.2 mm, at most 1 mm, at most 0.9 mm, at most 0.8 mm, at most 0.7 mm, at most 0.6 mm, at most 0.5 mm, at most 0.4 mm, or at most 0.3 mm.
A29. The customized temporary veneer of any of paragraphs A27-A28, wherein the vestibular region thickness is constant, or at least substantially constant, within the corresponding vestibular region.
A30. The customized temporary veneer of any of paragraphs A27-A29, wherein the gum-proximate edge thickness is at least one of:
(i) at least 0.05 mm, at least 0.1 mm, at least 0.15 mm, at least 0.2 mm, at least 0.25 mm, at least 0.3 mm, at least 0.35 mm, at least 0.4 mm, at least 0.45 mm, at least 0.5 mm, at least 0.55 mm, or at least 0.6 mm; and
(ii) at most 0.9 mm, at most 0.8 mm, at most 0.7 mm, at most 0.6 mm, at most 0.5 mm, at most 0.4 mm, or at most 0.3 mm.
A31. The customized temporary veneer of any of paragraphs A27-A30, wherein a ratio of the gum-proximate edge thickness to the vestibular region thickness is at least one of:
(i) at least 0.15, at least 0.2, at least 0.25, at least 0.3, at least 0.35, at least 0.4, at least 0.45, at least 0.5, at least 0.55, or at least 0.6; and
(ii) at most 0.9, at most 0.85, at most 0.8, at most 0.75, at most 0.7, at most 0.65, at most 0.6, at most 0.55, at most 0.5, at most 0.45, at most 0.4, at most 0.35, at most 0.3, at most 0.25, at most 0.2, at most 0.15, or at most 0.1.
A32. The customized temporary veneer of any of paragraphs A27-A31, wherein the gum-proximate region tapers along a gum-proximate edge region taper length of at least one of:
(i) at least 0.5 mm, at least 0.75 mm, at least 1 mm, at least 1.25 mm, at least 1.5 mm, at least 1.75 mm, or at least 2 mm; and
(ii) at most 4 mm, at most 3.75 mm, at most 3.5 mm, at most 3.25 mm, at most 3 mm, at most 2.75 mm, at most 2.5 mm, at most 2.25 mm, or at most 2 mm.
A33. The customized temporary veneer of any of paragraphs A1-A32, wherein the customized temporary veneer further includes a/the lingual region, which extends away from an/the incisal region of the customized temporary veneer and is configured to extend at least one of at least partially along a/the lingual surface of at least a subset of the plurality of corresponding teeth and toward a gumline of the individual's dental arch.
A34. The customized temporary veneer of paragraph A33, wherein the lingual region tapers from an incisal region thickness of the incisal region to a lingual region edge that defines a lingual region edge thickness.
A35. The customized temporary veneer of paragraph A34, wherein a ratio of the lingual region edge thickness to the incisal region thickness is at least one of:
(i) at least 0.15, at least 0.2, at least 0.25, at least 0.3, at least 0.35, at least 0.4, at least 0.45, at least 0.5, at least 0.55, or at least 0.6; and
(ii) at most 0.9, at most 0.85, at most 0.8, at most 0.75, at most 0.7, at most 0.65, at most 0.6, at most 0.55, at most 0.5, at most 0.45, at most 0.4, at most 0.35, at most 0.3, at most 0.25, at most 0.2, at most 0.15, or at most 0.1.
A35.1. The customized temporary veneer of any of paragraphs A27-A35, wherein a ratio of a/the lingual region edge thickness to a/the incisal region thickness is at least one of:
(i) at least 0.15, at least 0.2, at least 0.25, at least 0.3, at least 0.35, at least 0.4, at least 0.45, at least 0.5, at least 0.55, or at least 0.6; and
(ii) at most 0.9, at most 0.85, at most 0.8, at most 0.75, at most 0.7, at most 0.65, at most 0.6, at most 0.55, at most 0.5, at most 0.45, at most 0.4, at most 0.35, at most 0.3, at most 0.25, or at most 0.2.
A36. The customized temporary veneer of any of paragraphs A34-A35.1, wherein the lingual region tapers along a lingual region taper length of at least one of:
(i) at least 0.5 mm, at least 0.75 mm, at least 1 mm, at least 1.25 mm, at least 1.5 mm, at least 1.75 mm, or at least 2 mm; and
(ii) at most 4 mm, at most 3.75 mm, at most 3.5 mm, at most 3.25 mm, at most 3 mm, at most 2.75 mm, at most 2.5 mm, at most 2.25 mm, or at most 2 mm.
A37. The customized temporary veneer of any of paragraphs A1-A36, wherein the customized temporary veneer defines a tooth-facing side, which faces toward the individual's dental arch, wherein the customized temporary veneer is shaped to maintain a gap between the tooth and at least a fraction of the tooth-facing side.
A38. The customized temporary veneer of paragraph A37, wherein the fraction of the tooth-facing side includes at least one of:
(i) at least 25%, at least 30%, at least 35%, at least 40%, at least 45%, at least 50%, at least 55%, at least 60%, at least 65%, at least 70%, at least 75%, at least 80%, at least 85%, at least 90%, or at least 95%; and
(ii) at most 99%, at most 95%, at most 90%, at most 85%, at most 80%, at most 75%, at most 70%, at most 65%, at most 60%, at most 55%, or at most 50%.
A39. The customized temporary veneer of any of paragraphs A37-A38, wherein the fraction of the tooth-facing side excludes at least one, and optionally both, of:
(i) a/the gum-proximate edge, or an entirety of the gum-proximate edge, of the corresponding vestibular region; and
(ii) a/the lingual region edge, or an entirety of the lingula region edge, of a/the lingual region of the customized temporary veneer.
A40. The customized temporary veneer of any of paragraphs A37-A39, wherein the gap defines a gap width, or an average gap width, of at least one of:
(i) at least 0.005 mm, at least 0.01 mm, at least 0.015 mm, at least 0.02 mm, at least 0.025 mm, at least 0.3 mm, at least 0.35 mm, or at least 0.4 mm; and
(ii) at most 0.05 mm, at most 0.045 mm, at most 0.04 mm, at most 0.035 mm, at most 0.03 mm, at most 0.025 mm, or at most 0.02 mm.
A41. The customized temporary veneer of any of paragraphs A1-A40, wherein the customized temporary veneer is a composite customized temporary veneer optionally defined by at least one of:
(i) a plurality of different materials;
(ii) a plurality of different material regions; and
(iii) a plurality of assembled components.
A42. The customized temporary veneer of any of paragraphs A1-A41, wherein the corresponding vestibular region is defined by a vestibular region material, and further wherein the at least one joining region is defined by a joining region material.
A43. The customized temporary veneer of paragraph A42, wherein the customized temporary veneer further includes at least one of:
(i) an/the incisal region, which is defined by an incisal region material, extends from the corresponding vestibular region of at least a subset of the plurality of tooth-covering regions, and is configured to extend at least partially along an incisal surface of the corresponding tooth; and
(ii) a/the lingual region, which is defined by a lingual region material, extends away from the incisal region, and is configured to extend at least partially along a/the lingual surface of at least a subset of the plurality of teeth.
A44. The customized temporary veneer of paragraph A43, wherein at least one of:
(i) the vestibular region material differs from the joining region material;
(ii) the vestibular region material differs from the incisal region material;
(iii) the vestibular region material differs from the lingual region material;
(iv) the joining region material differs from the incisal region material;
(v) the joining region material differs from the lingual region material; and
(vi) the lingual region material differs from the incisal region material.
A45. The customized temporary veneer of any of paragraphs A43-A44, wherein the customized temporary veneer defines an abrupt transition at least one of:
(i) between the vestibular region material and the joining region material;
(ii) between the vestibular region material and the incisal region material;
(iii) between the vestibular region material and the lingual region material;
(iv) between the joining region material and the incisal region material;
(v) between the joining region material and the lingual region material; and
(vi) between the lingual region material and the incisal region material.
A46. The customized temporary veneer of any of paragraphs A43-A45, wherein the customized temporary veneer defines a gradient transition at least one of:
(i) between the vestibular region material and the joining region material;
(ii) between the vestibular region material and the incisal region material;
(iii) between the vestibular region material and the lingual region material;
(iv) between the joining region material and the incisal region material;
(v) between the joining region material and the lingual region material; and
(vi) between the lingual region material and the incisal region material.
A47. The customized temporary veneer of any of paragraphs A43-A46, wherein the incisal region material defines a greater hardness than at least one of the joining region material, the lingual region material, and the vestibular region material.
A48. The customized temporary veneer of any of paragraphs A43-A47, wherein the joining region material defines a greater flexibility than at least one of the lingual region material, the vestibular region material, and the incisal region material.
A49. The customized temporary veneer of any of paragraphs A43-A48, wherein the customized temporary veneer includes an interlock structure at least one of defined by, extending between, and mechanically interlocking at least one of:
(i) the vestibular region material and the joining region material;
(ii) the vestibular region material and the incisal region material;
(iii) the vestibular region material and the lingual region material;
(iv) the joining region material and the incisal region material;
(v) the joining region material and the lingual region material; and
(vi) the lingual region material and the incisal region material.
A50. The customized temporary veneer of paragraph A49, wherein the interlock structure includes at least one of:
(i) a region of increased surface area;
(ii) a zipper-shaped structure;
(iii) a rounded zipper-shaped structure;
(iv) a wavy region;
(v) a zigzag region;
(vi) a sawtooth region; and
(vii) a hinge.
A50.1. The customized temporary veneer of any of paragraphs A49-A50, wherein the interlock structure at least partially defines a corresponding joining region.
A51. The customized temporary veneer of any of paragraphs A1-A50.1, wherein the customized temporary veneer is a 3D printed customized temporary veneer.
A52. The customized temporary veneer of any of paragraphs A1-A51, wherein the customized temporary veneer further includes a surface treatment.
A53. The customized temporary veneer of paragraph A52, wherein the surface treatment locally modifies an aesthetic property of the customized temporary veneer, optionally wherein the aesthetic property includes at least one of a color, a shade, and an opacity of the customized temporary veneer.
A54. The customized temporary veneer of any of paragraphs A52-A53, wherein the surface treatment locally modifies a mechanical property of the customized temporary veneer, optionally wherein the mechanical property includes at least one of a flexibility, a stiffness, and a smoothness of the customized temporary veneer.
A55. The customized temporary veneer of any of paragraphs A52-A54, wherein the surface treatment includes at least one of a polished region, a glazed region, and a coated region of the customized temporary veneer.
A56. The customized temporary veneer of any of paragraphs A1-A55, wherein the customized temporary veneer further includes a/the gum-proximate region that extends from the plurality of tooth-covering regions and is configured to extend at least partially, or even completely, between the plurality of tooth-covering regions and a/the gum of the individual's dental arch.
A57. The customized temporary veneer of paragraph A56, wherein the gum-proximate region is configured to at least partially overlap with the gum.
A58. The customized temporary veneer of any of paragraphs A56-A57, wherein the gum-proximate region is at least partially colored to match a color of the gum.
A58.1. The customized temporary veneer of any of paragraphs A56-A58, wherein the gum-proximate region at least one of:
(i) defines a/the gum-proximate edge of the veneer;
(ii) includes the gum-proximate edge of the veneer;
(iii) tapers toward the gum-proximate edge of the veneer;
(iv) extends within a/the gum-proximate edge region taper length of the veneer;
(v) is at least partially defined by a gum-proximate edge region material, optionally that is relatively softer than a/the vestibular region material;
(vi) includes at least one of a different color, a different aesthetic, and a different opacity compared to at least one of an/the incisal region, the joining region, the a/the lingula region, and the vestibular region;
(vii) is colored to match the individual's gums;
(viii) extends from an artificial gumline between the vestibular region and the gum-proximate region;
(ix) extends over, or only over, the individual's teeth; and
(x) extends over, or only over, the individual's gums.
A59. The customized temporary veneer of any of paragraphs A1-A58.1, wherein the customized temporary veneer further includes a support structure configured to support the customized temporary veneer when unattached from the target region of the individual's dental arch.
A60. The customized temporary veneer of paragraph A59, wherein the support structure is at least partially, or even completely, shaped to correspond to a shape of the individual's dental arch.
A61. The customized temporary veneer of any of paragraphs A1-A60, wherein the customized temporary veneer is free from at least one of:
(i) an adhesive attachment to the target region of the individual's dental arch; and
(ii) a bone mount to the target region of the individual's dental arch.
A62. The customized temporary veneer of any of paragraphs A1-A61, wherein the customized temporary veneer is configured to be temporarily attached to the target region of the individual's dental arch without modification to the individual's dental arch.
A63. The customized temporary veneer of any of paragraphs A1-A62, wherein at least a subset of the plurality of tooth-covering regions includes an/the incisal region, which is configured to extend at least partially along an/the incisal surface of at least a subset of the plurality of corresponding teeth, and further wherein an exposed incisal surface of the incisal region is relatively sharper than a corresponding incisal surface along which the incisal region extends.
A64. The customized temporary veneer of any of paragraphs A1-A63, wherein the plurality of corresponding teeth includes at least one of:
(i) at least 2, at least 4, at least 6, at least 8, at least 10, at least 12, or at least 14 teeth; and
(ii) at most 16, at most 14, at most 12, at most 10, at most 8, at most 6, at most 4, or at most 2 teeth.
A65. The customized temporary veneer of any of paragraphs A1-A64, wherein the customized temporary veneer is configured to deliver a medication to the individual's mouth.
A66. The customized temporary veneer of paragraph A65, wherein the customized temporary veneer is infused with the medication and is configured to release the medication upon being positioned within the individual's mouth.
A67. The customized temporary veneer of any of paragraphs A65-A66, wherein the customized temporary veneer includes a medication reservoir configured to release the medication while the customized temporary veneer is positioned within the individual's mouth.
A68. The customized temporary veneer of any of paragraphs A1-A67, wherein the customized temporary veneer includes a filler region shaped to replace at least a region of at least one tooth within the individual's dental arch.
A69. The customized temporary veneer of paragraph A68, wherein the filler region is configured to support the customized temporary veneer to decrease a potential for breakage of the customized temporary veneer.
A70. The customized temporary veneer of any of paragraphs A68-A70, wherein the filler region is shaped to maintain a desired gap between adjacent teeth within the individual's dental arch.
A71. The customized temporary veneer of any of paragraphs A68-A70, wherein the filler region is shaped to avoid continuous direct contact with a/the gum of the individual's dental arch.

### INDUSTRIAL APPLICABILITY

The customized temporary veneers disclosed herein are applicable to the dentistry, orthodontics, and cosmetic industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A customized temporary veneer configured to be temporarily attached to a target region of an individual's dental arch, the customized temporary veneer comprising:
a plurality of tooth-covering regions, wherein each tooth-covering region of the plurality of tooth-covering regions includes a corresponding vestibular region configured to at least partially cover a vestibular surface of a corresponding tooth of a plurality of corresponding teeth of the dental arch;
at least one joining region that operatively attaches a pair of adjacent tooth-covering regions of the plurality of tooth-covering regions to one another; and
a gum-proximate region that extends from the plurality of tooth-covering regions and is configured to extend at least partially between the plurality of tooth-covering regions and a gum of the individual's dental arch, wherein the corresponding vestibular region defines a vestibular region thickness, wherein the gum-proximate region tapers from the vestibular region thickness to a gum-proximate edge that defines a gum-proximate edge thickness, and further wherein a ratio of the gum-proximate edge thickness to the vestibular region thickness is at least 0.15 and at most 0.9.

2. The customized temporary veneer of claim 1, wherein the vestibular region thickness is at least 0.1 millimeters (mm) and at most 2 mm, and wherein the gum-proximate edge thickness is at least 0.05 mm and at most 0.9 mm.

3. The customized temporary veneer of claim 1, wherein the gum-proximate region tapers along a gum-proximate edge region taper length of at least 0.5 mm and at most 4 mm.

4. The customized temporary veneer of claim 1, wherein at least a subset of the plurality of tooth-covering regions further includes an incisal region that extends from the vestibular region and at least partially along an incisal surface of at least a subset of the plurality of corresponding teeth.

5. The customized temporary veneer of claim 4, wherein the subset of the plurality of corresponding teeth excludes at least one of:
(i) at least one incisor;
(ii) at least one canine; and
(iii) at least one premolar.

6. The customized temporary veneer of claim 4, wherein the subset of the plurality of corresponding teeth includes at least one of:
(i) at least one molar;
(ii) at least one premolar; and
(iii) at least one canine.

7. The customized temporary veneer of claim 4, wherein an extent to which the incisal region extends along the incisal surface of at least one tooth in the subset of the plurality of corresponding teeth differs from an extent to which the incisal region extends along the incisal surface of at least one other tooth in the subset of the plurality of corresponding teeth.

8. The customized temporary veneer of claim 1, wherein the customized temporary veneer defines a tooth-facing side, which faces toward the individual's dental arch, and further wherein the customized temporary veneer is shaped to maintain a gap between the tooth and at least a fraction of the tooth-facing side.

9. The customized temporary veneer of claim 8, wherein the fraction of the tooth-facing side is at least 25% and at most 99%.

10. The customized temporary veneer of claim 8, wherein the fraction of the tooth-facing side excludes at least one of:
(i) a gum-proximate edge of the corresponding vestibular region; and
(ii) a lingual region edge of a lingual region of the customized temporary veneer.

11. The customized temporary veneer of claim 8, wherein the gap defines an average gap width of at least 0.005 mm and at most 0.05 mm.

12. The customized temporary veneer of claim 1, wherein the customized temporary veneer further includes a surface treatment, and further wherein at least one of:
(i) the surface treatment locally modifies an aesthetic property of the customized temporary veneer;
(ii) the surface treatment locally modifies a mechanical property of the customized temporary veneer; and
(iii) the surface treatment includes at least one of a polished region, a glazed region, and a coated region of the customized temporary veneer.

13. The customized temporary veneer of claim 1, wherein the customized temporary veneer includes a filler region shaped to replace at least a region of at least one tooth within the individual's dental arch.

14. The customized temporary veneer of claim 13, wherein the filler region is configured to support the customized temporary veneer to decrease a potential for breakage of the customized temporary veneer.

15. The customized temporary veneer of claim 13, wherein the filler region is shaped to maintain a desired gap between adjacent teeth within the individual's dental arch.

16. The customized temporary veneer of claim 13, wherein the filler region is shaped to avoid continuous direct contact with a gum of the individual's dental arch.

17. The customized temporary veneer of claim 1, wherein the customized temporary veneer is at least partially defined by a flexible polymeric material, wherein the flexible polymeric material includes at least one of a polymeric resin, an epoxy, and a dental resin, and wherein the flexible polymeric resin is a biocompatible flexible polymeric resin.

18. The customized temporary veneer of claim 17, wherein at least one of:
(i) the flexible polymeric material defines a flexural strength of at least 50 megapascals (MPa) and at most 76 MPa; and
(ii) the flexible polymeric material defines a flexural modulus of at least 1300 MPa and at most 1900 MPa.

19. The customized temporary veneer of claim 17, wherein the flexible polymeric material defines an elongation at break of at least 10% and at most 70%.

20. The customized temporary veneer of claim 17, wherein the flexible polymeric material defines a Shore D Hardness of at least 70D and at most 90D.

21. The customized temporary veneer of claim 17, wherein the flexible polymeric material defines a water sorption of at least 6 micrograms per cubic millimeter (ug/mm³) and at most 35 ug/mm³.

22. The customized temporary veneer of claim 17, wherein the flexible polymeric material defines a water solubility of at least 0.5 ug/mm³ and at most 6 ug/mm³.

23. The customized temporary veneer of claim 17, wherein the at least one joining region includes a flexible joining region that is at least partially defined by the flexible polymeric material.
